(19) United States
(12) Patent Application Publication
(10) Pub. No.: US 2006/0256801 A1
(43) Pub. Date: Nov. 16, 2006

(54) Gateway system

(75) Inventor: Masahito Endo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/407,944

(22) Filed: Apr. 21, 2006

(30) Foreign Application Priority Data
Apr. 26, 2005 (JP) P.2005-127551

(51) Int. Cl. H04L 12/56

(52) U.S. Cl. 370/401

(57) ABSTRACT

A gateway system for transiting communications at the boundary between networks includes a master gateway and at least one slave gateway. The master gateway processes a communication packet, updates state information based on the processing of the communication packet, and transmits the updated state information. The slave gateway receives state information transmitted from the master gateway, and stores the received state information as state information of the slave gateway. The slave gateway operates instead of the master gateway based on the stored state information.

### CROSS-REFERENCE TO RELATED APPLICATIONS

This application is based upon and claims the benefit of priority from the prior Japanese Patent Applications No. 2005-127551, filed on Apr. 26, 2005, the entire contents of which are incorporated herein by reference.

### BACKGROUND OF THE INVENTION

1. Field of the Invention

This invention relates to a gateway system used for communications between apparatus such as computers, and in particular to a gateway system intended for improving the reliability of communications.

2. Description of the Related Art

While the Internet, an intra-company network, and the like become widespread, it is necessary to provide a stable network. Often, a gateway such as an NAT (Network Address Translation) unit or a firewall unit is introduced into the boundary between an intra-company network and the Internet. In the gateway, the address translation rule, the rule of security including a filter, and the like based on the operation policy of the organization are set.

A gateway is also used in the system bus boundary of an operation supervisory system in control of a plant, etc., as transit (relay) of data.

If such a gateway stops due to problems, communications are made impossible and thus hitherto gateways have been designed with redundancy. (For example, refer to JP-A-S62-5748.) JP-A-S62-5748 is referred to as a related art.

Recently, using a protocol for redundancy of routers such as VRRP (Virtual Router Redundancy Protocol), an arrangement has been used wherein a plurality of routers is made to belong to one group and usually one of the routers conducts communications and when the router becomes faulty, another router belonging to the same group automatically takes over the communications.

FIG. 12 is a block diagram to show an example of a gateway system in a related art.

In FIG. 12, a server 3 and gateways 300 and 400 are connected by a network 6, a client PC 4 and the gateways 300 and 400 are connected by a network 7, and the gateway 300 performs actual processing as a master in communications between the server 3 and the client PC 4. The gateway 400 operates as a slave and monitors the gateway 300 of the master.

As a precondition, the gateways 300 and 400 are recognized as one virtual gateway viewed from the client PC 4 and the server 3. The mechanism is defined in the VRRP, for example, and therefore is not mentioned here. Each of the gateways 300, 400 has a processing section 301, 401 and a storage section 303, 403. The processing section 301, 401 is a section for processing a packet and performs different processing depending on the gateway type; for example, if the gateway is an NAT unit, the processing section performs address translation processing; if the gateway is a firewall unit, the processing section performs filtering; and if the gateway is a translator, the processing section performs protocol translation processing, etc.

Rule information and state information are stored in a storage section 303, 403. The rule information varies depending on the gateway type; for example, if the gateway is an NAT unit or a translator, the rule information is the address translation rule; and if the gateway is a firewall unit, the rule information is the filter rule, etc. The state information varies depending on the gateway type; for example, the state information is source/destination address, source/destination port number, session state, etc.

An operation example is shown below: Signal names used in FIG. 12 and the following processing steps are made to correspond to each other.
(S01) The client PC 4 starts communications with the server 3.
(S02) The gateway 300 receives the packet transmitted from the client PC 4 at S01. The processing section 301 references the state information and the rule information in order for determining whether or not the packet is to be processed. Since the packet at S01 is the first processed packet in the gateway 300, no corresponding entry exists in the state information in the storage section 303. The processing section 301 references the rule information for determining whether or not the packet is to be processed.
(S03) If the packet is to be processed, the processing section 301 processes the packet received at S01 and adds a new entry to the state information in the storage section 303 based on the rule information.
(S04) The gateway 300 transmits the processed packet to the server 3.
(S05) The server 3 receives the packet transmitted at S04 and makes a response.
(S06) The gateway 300 receives the packet transmitted from the server 3 at S05. The processing section 301 references the state information and the rule information in order for determining whether or not the packet is to be processed. Since the packet at S05 is the packet concerning communications, already processed by the gateway 300, the corresponding state information is stored in the storage section 303 and therefore the packet is determined to be processing section 301 updates the state information.
(S07) The gateway 300 transmits the processed packet to the client PC 4. After this, it is assumed that the gateway 300 cannot continue the processing because of a fault, etc. At this time, the gateway 400 operating as a slave detects the fault in the gateway 300 of the master. The gateway 400 detecting the fault starts to operate as the master and performs actual processing.
(S08) The client PC 4 transmits a packet. This packet belongs to the already existing session.
(S09) The processing section 401 of the gateway 400 receives the packet transmitted from the client PC 4 at S08. The processing section 401 references the state information and the rule information in the storage section 403 in order for determining whether or not the packet is to be processed. Since the packet at S08 is the first processed packet in the gateway 400, no corresponding entry exists in the state information in the storage section 403. The processing section 401 references the rule information for determining whether or not the packet is to be processed.
(S10) If the packet is to be processed, the processing section 401 processes the packet received at S08 and adds a new entry to the state information in the storage section 300 and 400 manage the state information separately and therefore the entry differs in information from the entry generated by the gateway 300 at S03.
(S11) The gateway 400 transmits the processed packet to the server 3. However, the server 3 discards the packet because the session relevant to S11 does not exist. Since the server 3 discards the packet, the connection of the server 3 and the client PC 4 is disconnected as processing of a timeout, etc., is performed.

It is also possible that the following disadvantage may occur:

FIG. 13 is another operation schematic representation of the gateway system in the related art.

In FIG. 13, the gateways 300 and 400 exist as in FIG. 12. At this time, the gateway 300 performs actual processing as the master. The gateway 400 operates as a slave and monitors the gateway 300 of the master. Similar rule information is applied to the gateways 300 and 400.

The operation is as follows: Signal names used in FIG. 13 and the following processing steps are made to correspond to each other.
(S01) The client PC 4 starts communications with the server 3.
(S02) The gateway 300 receives the packet transmitted from the client PC 4 at S01. The processing section 301 references the state information and the rule information in the storage section 303 in order for determining whether or not the packet is to be processed. Since the packet at S01 is the first processed packet in the gateway 300, no corresponding entry exists in the state information in the storage section 303. The processing section 301 references the rule information for determining whether or not the packet is to be processed.
(S03) If the packet is to be processed, the processing section 301 processes the packet received at S01 and adds a new entry to the state information in the storage section 303 based on the rule information.
(S04) The gateway 300 transmits the processed packet to the server 3. After this, it is assumed that the gateway 300 cannot continue the processing because of a fault, etc. At this time, the gateway 400 operating as a slave detects the fault in the gateway 300 of the master. The gateway 400 detecting the fault starts to operate as the master and performs actual processing.
(S05) The server 3 receives the packet transmitted at S04 and makes a response.
(S06) The processing section 401 of the gateway 400 receives the packet transmitted from the server 3 at 505. The processing section 401 references the state information and the rule information in the storage section 403 in order for determining whether or not the packet is to be processed. Since the packet at S05 is the first processed packet in the gateway 400, no corresponding entry exists in the state information in the storage section 403. The processing section 401 references the rule information for determining whether or not the packet is to be processed. At this time, if a rule to the effect that communications shall start at a client is set in the rule information, the processing section 401 of the gateway 400 determines that the packet sent from the server 3 is not to be processed. In this case, the gateway 400 discards the packet. Since the gateway 400 discards the packet, the connection of the server 3 and the client PC 4 is disconnected as processing of a timeout, etc., is performed.

In such a gateway system in the related art, if a redundant system of gateways is provided for attempting to obtain high availability to improve the operating ratio, it may become impossible to continue communications conducted through the gateways unless the state information is not synchronized as described above; this is a problem.

### SUMMARY OF THE INVENTION

An object of the invention is to provide a gateway system wherein state information is synchronized among gateways, whereby continuous processing can be performed if one of the gateways adopting high-availability configuration is switched into another gateway due to a fault, etc.

The invention provides the following gateway system.

The invention provides a gateway system for transiting communications at the boundary between networks, including:

a master gateway which processes a communication packet, updates state information based on the processing of the communication packet, and transmits the updated state information; and

at least one slave gateway which receives state information transmitted from the master gateway, and stores the received state information as state information of the slave gateway,

wherein the slave gateway operates instead of the master gateway based on the stored state information.

The gateway system further includes a plurality of the master gateways, wherein the slave gateway stores state information transmitted from each of the plurality of the master gateways.

In the gateway system, the master gateway includes:

a processing section which processes a communication packet, and updates state information based on the

a storage section which stores state information; and

a synchronous processing section which transmits state information.

In the gateway system, the slave gateway includes:

a synchronous processing section which receives the state information transmitted from the master gateway;

a processing section which processes communication packet, and updates the currently stored state information to the received state information; and

a storage section which stores state information.

In the gateway system, the processing section of the salve gateway updates state information when the processing section processes a communication packet, and the synchronous processing section transmits the updated state information to another slave gateway.

In the gateway system, the synchronous processing section of the salve gateway notifies another gateway that a function becomes effective at an operation start time, and transmits a request signal of state information to the master gateway.

The gateway system provides the following advantages:

Since the master gateway and the slave gateway share the state information in synchronization, continuous processing can be performed if the gateway is switched due

The master gateways and the slave gateway share the state information in synchronization. Thus, the slave gateway is installed so as to belong to a plurality of groups, whereby the system can be designed flexibly.

If one of the slave gateways is switched to the master gateway, it shares the state information with any other salve gateway in synchronization, whereby the gateways can be furthermore made redundant and highly available.

Another gateway is notified that the function of an added gateway becomes effective and a request for sending state information is also transmitted to the master gateway, whereby it is made possible to add a gateway as desired.

### BRIEF DESCRIPTION OF THE DRAWINGS

FIG. 1 is a block diagram to show of a first embodiment of a gateway system according to the invention;

FIG. 2 is a diagram to describe the configuration of networks according to the invention;

FIG. 3 is a packet flow chart in the configuration in FIG. 1;

FIG. 4 is a diagram to describe the case where a gateway is switched during communications;

FIG. 6 is a block diagram to show a second embodiment according to the invention;

FIG. 7 is a diagram to describe the configuration of networks according to the invention;

FIG. 8 is a packet flow chart in the configuration in FIG. 6;

FIG. 9 is a block diagram to show a third embodiment according to the invention;

FIG. 10 is a diagram to describe the configuration of networks according to the invention;

FIG. 11 is a packet flow chart in the configuration in FIG. 9;

FIG. 12 is a block diagram to show an example of a gateway system in a related art; and

FIG. 13 is another operation schematic representation of the gateway system in the related art.

### DETAILED DESCRIPTION OF THE PREFERRED EMBODIMENTS

Embodiments of the invention will be discussed in detail with the accompanying drawings.

### First Embodiment

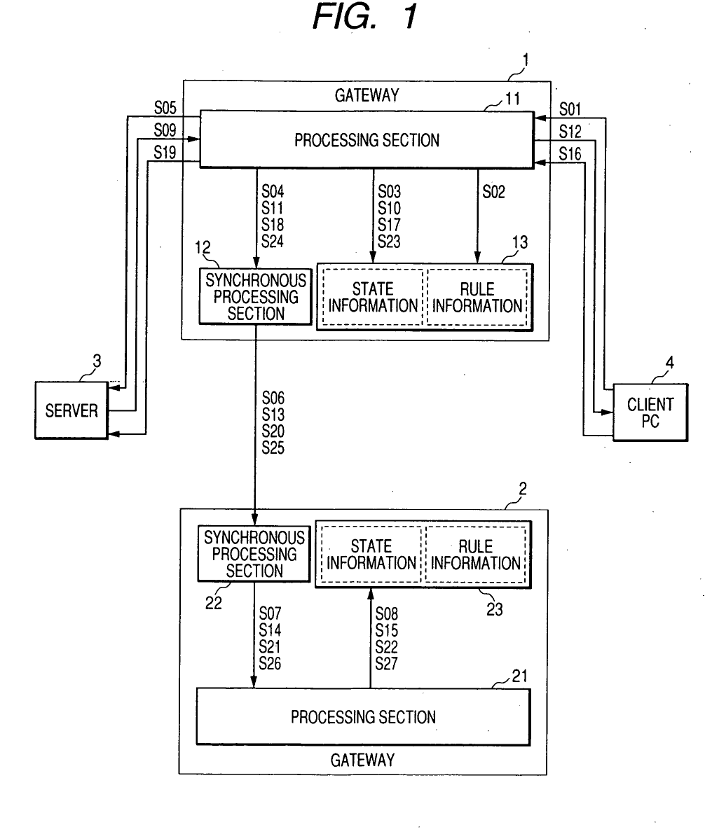

FIG. 1 is a block diagram to show of a first embodiment of a gateway system according to the invention.

In FIG. 1, a gateway 1, 2 has a processing section 11, 21 a synchronous processing section 12, 22, and a storage section 13, 23. The processing section 11, 21 is a section for processing a packet and performs different processing depending on the gateway type (gateway 1 or 2); for example, if the gateway is an NAT unit, the processing section performs address translation processing; if the gateway is a firewall unit, the processing section performs filtering; and if the gateway is a translator, the processing section performs protocol translation processing, etc.

A storage section 13, 23 is memory in which rule information and state information are stored by the processing section 11, 21. For example, if the gateway is an NAT unit or a translator, the rule information corresponds to the address translation rule; and if the gateway is a firewall unit, the rule information corresponds to the filter rule, etc. The state information is information indicating what state the client PC and the server have been in so far for the gateway, such as the source/destination address, the source/destination port number, the session state, etc.

The synchronous processing section 12, 22 receives a notification from the processing section 11, 21 when the state information is updated, gets the updated state information through the processing section 11, 21 from the to the associated gateway. The synchronous processing section 12, 22 also stores the state information transmitted from the associated gateway through the processing section 11, 21 in the storage section 13, 23.

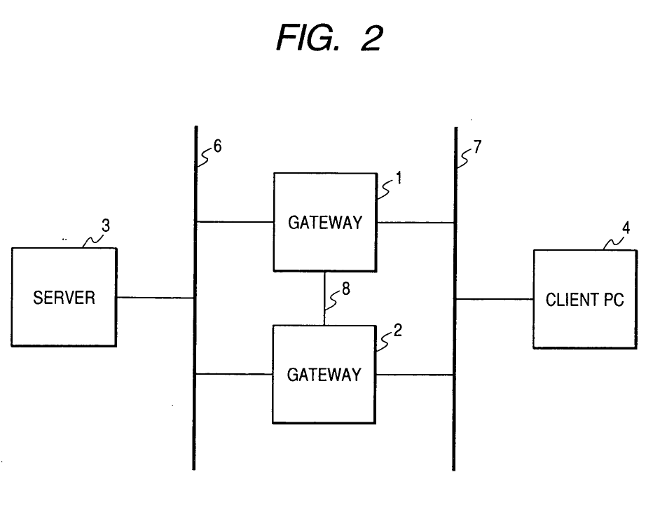

FIG. 2 is a diagram to describe the configuration of networks according to the invention.

In FIG. 2, the server 3 and the gateways 1 and 2 are connected by a network 6. The client PC 4 and the gateways 1 and 2 are connected by a network 7. The gateway 1 performs actual processing as the master in communications between the server 3 and the client PC 4. The gateways 1 and 2 are connected by a dedicated line 8.

Here, data transfer between the gateways 1 and 2 may be executed via the dedicated line 8 or may be executed through the network 6 or 7 without providing the dedicated line.

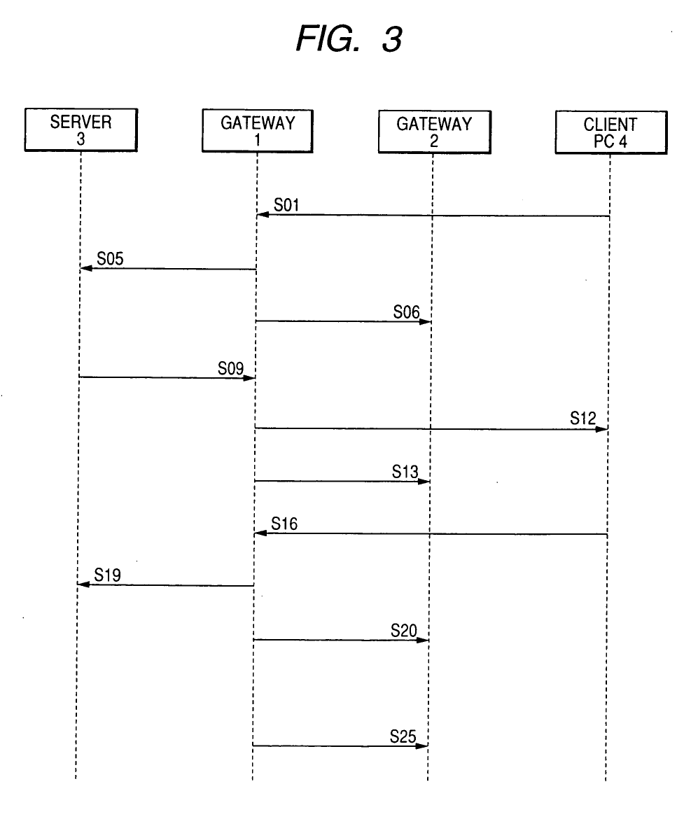

FIG. 3 is a packet flow chart in the configuration in FIG. 1.

The detailed operation will be discussed with FIGS. 1 and 3. The following processing steps are made to correspond to signal names in FIGS. 1 and 3.
(S01) The client PC 4 starts communications with the server 3.
(S02) The processing section 11 of the gateway 1 receives processing section 11 references the state information and the rule information in the storage section 13 in order for determining whether or not the packet is to be processed. Since the packet at S01 is the first processed packet in the gateway 1, no corresponding entry exists in the state information in the storage section 13. The processing section 11 references the rule information for determining whether or not the packet is to be processed.
(S03) If the packet is to be processed, the processing section 11 processes the packet received at S01 and adds a new entry to the state information in the storage section 13 based on the rule information.
(S04) The processing section 11 of the gateway 1 updates the state information and thus sends a notification to the synchronous processing section 12 in the gateway 1.
(S05) The processing section 11 of the gateway 1 transmits the processed packet to the server 3.
(S06) The synchronous processing section 12 of the gateway 1 gets the updated state information through the processing section 11 almost at the same time as or before or after the packet at S05 and gives a notice to the different gateway.
(307) The synchronous processing section 22 of the gateway 2 receives S06 of the notice packet of the state information and passes the information to the process in section 21.
(S08) The processing section 21 of the gateway 2 updates the state information in the storage section 23 based on the received information.
(S09) The server 3 receives the packet transmitted at S05 and makes a response.
(S10) The processing section 11 of the gateway 1 receives the packet transmitted from the server 3 at S09. The processing section 11 references the state information and the rule information in the storage section 13 in order for determining whether or not the packet is to be processed. Since the packet at S09 is the packet concerning communications, already processed by the processing section 11 of the gateway 1, corresponding information is stored in the state information in the storage section 13 and therefore the packet is determined to be processed. Because of performing packet processing, the processing section 11 updates the state information.
(S11) If the state information is updated, the processing section 11 of the gateway 1 sends a notification to the synchronous processing section 12 in the gateway 1 to give notice of the updated state information to the different gateway.
(S12) The processing section 11 of the gateway 1 transmits the processed packet to the client PC 4.
(S13) If the state information is updated, the synchronous processing section 12 of the gateway 1 gets the updated state information through the processing section 11 almost at the same time as or before or after the packet at S12 and gives a notice to the different gateway.
(S14) The synchronous processing section 22 of the gateway 2 receives S13 of the notice packet of the state information and passes the information to the processing section 21.
(S15) The processing section 21 of the gateway 2 updates the state information in the storage section 23 based on the received information.
(S16) The client PC 4 transmits a packet to the server 3.
(S17) The processing section 11 of the gateway 1 receives the packet transmitted from the client PC 4 at S16. The processing section 11 references the state information and the rule information in the storage section 13 in order for determining whether or not the packet is to be processed. Since the packet at S16 is the packet concerning communications, already processed by the processing section 11 of the gateway 1, corresponding information is stored in the state information in the storage section 13 and therefore the packet is determined to be processed. Because of performing packet processing, the processing section 11 updates the state information.
(S18) If the state information is updated, the processing section 11 of the gateway 1 sends a notification to the synchronous processing section 12 in the gateway 1 to give notice of the updated state information to the different gateway.
(S19) The processing section 11 of the gateway 1 transmits the processed packet to the server 3.
(S20) If the state information is updated, the synchronous processing section 12 of the gateway 1 gets the updated state information through the processing section 11 almost at the same time as or before or after the packet at S19 and gives a notice to the different gateway.
(S21) The synchronous processing section 22 of the gateway 2 receives S20 of the notice packet of the state information and passes the information to the processing section 21.
(S22) The processing section 21 of the gateway 2 updates the state information in the storage section 23 based on the received information.
(S23) If communications are not conducted between the client PC 4 and the server 3 after the expiration of a given time interval, the processing section 11 of the gateway 1 deletes the corresponding state information.
(S24) The processing section 11 of the gateway 1 sends a notification to the synchronous processing section 12 in the gateway 1 to give notice of the deleted state information to the gateway 2.
(S25) The synchronous processing section 12 of the gateway 1 gives notice of the deleted state information to the different gateway.
(S26) The synchronous processing section 22 of the gateway 2 receives S25 of the notice packet of the state information and passes the information to the processing section 21.
(S27) The processing section 21 of the gateway 2 deletes the state information in the storage section 23 based on the received information.

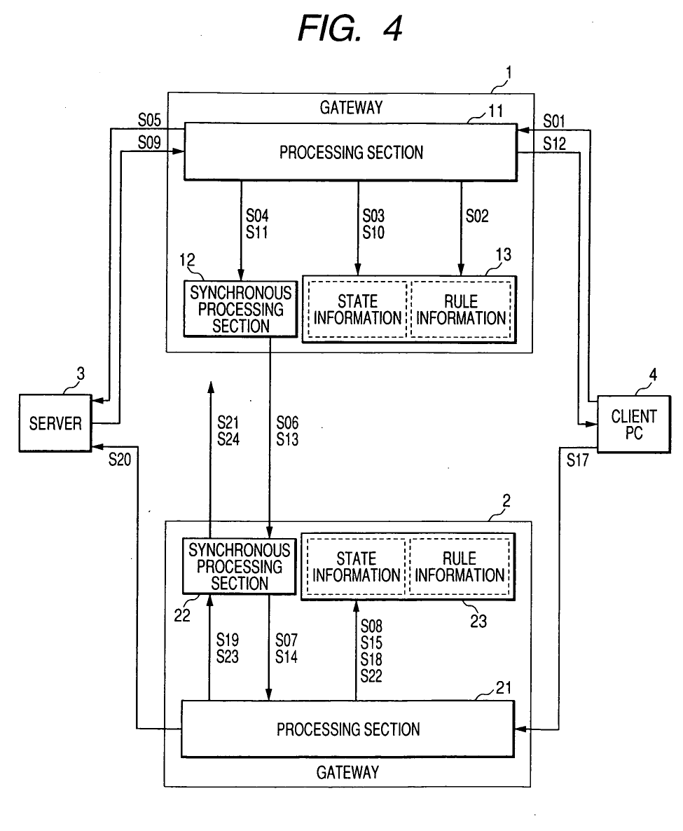

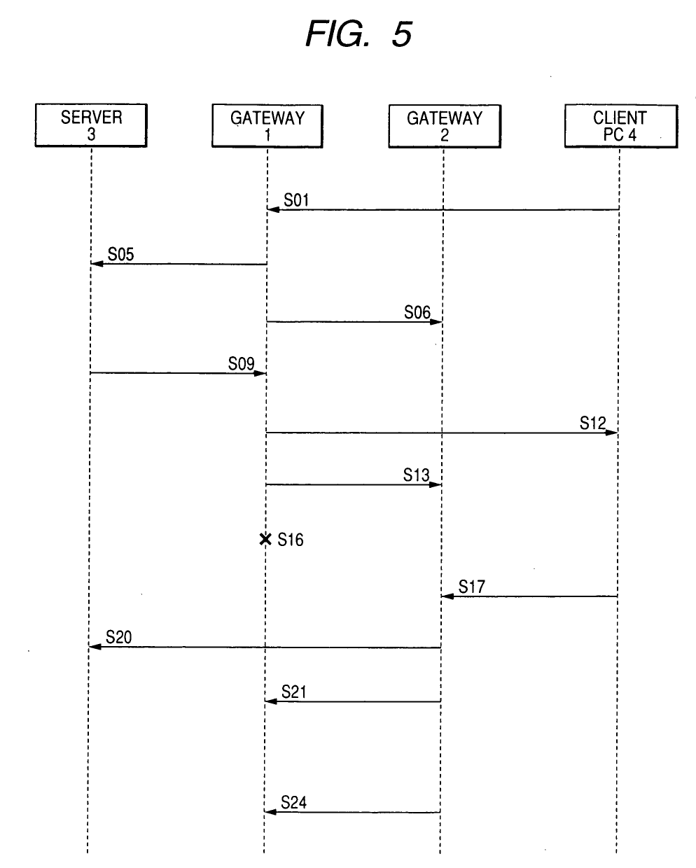

FIG. 4 is a diagram to describe the case where the gateway is switched during communications.

FIG. 5 is a packet flow chart in FIG. 4. The case where the gateway 1 is switched to the gateway 2 while communications are being conducted from the client PC 4 to the server 3 through the gateway 1 will be discussed with FIGS. 4 and 5.

Also in the operation example, the gateways 1 and 2 exist, the gateway 1 performs actual processing as the master, and the gateway 2 operates as a slave and monitors the gateway 1 of the master. The following processing steps are made to correspond to signal names in FIGS. 4 and
(S01) The client PC 4 starts communications with the server 3.
(S02) The processing section 11 of the gateway 1 receives the packet transmitted from the client PC 4 at S01. The processing section 11 references the state information and the rule information in the storage section 13 in order for determining whether or not the packet is to be processed. Since the packet at S01 is the first processed packet in the processing section 11 of the gateway 1, no corresponding entry exists in the state information in the storage section 13. The processing section 11 references the rule information for determining whether or not the packet is to be processed.
(S03) If the packet is to be processed, the processing section 11 processes the packet received at S01 and adds a new entry to the state information in the storage section 13 based on the rule information.
(S04) The processing section 11 of the gateway 1 updates the state information and thus sends a notification to the synchronous processing section 12 in the gateway 1.
(S05) The processing section 11 of the gateway 1 transmits the processed packet to the server 3.
(S06) The synchronous processing section 12 of the gateway 1 gets the updated state information through the processing the packet at S05 and gives a notice to the different gateway.
(S07) The synchronous processing section 22 of the gateway 2 receives S06 of the notice packet of the state information and passes the information to the processing section 21.
(S08) The processing section 21 of the gateway 2 updates the state information in the storage section 23 based on the received information.
(S09) The server 3 receives the packet transmitted at S05 and makes a response.
(S10) The processing section 11 of the gateway 1 receives the packet transmitted from the server 3 at S09. The processing section 11 references the state information and the rule information in the storage section 13 in order for determining whether or not the packet is to be processed. Since the packet at S09 is the packet concerning communications, already processed by the processing section 11 of the gateway 1, corresponding information is stored in the state information in the storage section 13 and therefore the packet is determined to be processed. Because of performing packet processing, the processing section 11 updates the state information.
(S11) If the state information is updated, the processing synchronous processing section 12 in the gateway 1 to give notice of the updated state information to the gateway 2.
(S12) The processing section 11 of the gateway 1 transmits the processed packet to the client PC 4.
(S13) If the state information is updated, the synchronous processing section 12 of the gateway 1 gets the updated state information through the processing section 11 almost at the same time as or before or after the packet at S12 and gives a notice to the different gateway.
(S14) The synchronous processing section 22 of the gateway 2 receives S13 of the notice packet of the state information and passes the information to the processing section 21.
(S15) The processing section 21 of the gateway 2 updates the state information in the storage section 23 based on the received information.
(S16) The processing section 11 of the gateway 1 cannot continue the processing due to a fault, etc. At this time, the processing section 21 of the gateway 2 operating as the slave detects the fault in the gateway 1 of the master. The processing section 21 of the gateway 2 detecting the fault starts to operate as the master and performs actual processing.
(S17) The client PC 4 transmits a packet to the server 3.
(S18) The processing section 21 of the gateway 2 receives the packet transmitted from the client PC 4 at S17. The processing section 21 references the state information and the rule information in the storage section 23 in order for determining whether or not the packet is to be processed. Although the packet at S17 is the first processed packet in the processing section 21 of the gateway 2, the state information of the gateway 1 and the state information of the gateway 2 are already synchronized with each other and thus the corresponding information is stored in the state information in the storage section 23 of the gateway 2. Therefore, the packet is determined to be processed. Because of performing packet processing, the processing section 11 updates the state information.
(S19) If the state information is updated, the processing section 21 of the gateway 2 sends a notification to the synchronous processing section 22 in the gateway 2 to give notice of the updated state information to the different gateway.
(S20) The processing section 21 of the gateway 2 transmits the processed packet to the server 3.
(S21) If the state information is updated, the synchronous processing section 22 of the gateway 2 gets the updated state information through the processing section 21 almost at the same time as or before or after the packet at S20 and gives a notice to the different gateway. At this time, the different gateway does not exist and therefore no processing is performed.
(S22) If communications are not conducted between the client PC 4 and the server 3 after the expiration of a given time interval, the processing section 21 of the gateway 2 deletes the corresponding state information.
(S23) The processing section 21 of the gateway 2 sends a notification to the synchronous processing section 22 in the gateway 2 to give notice of the deleted state information to the different gateway.
(S24) The synchronous processing section 22 of the gateway 2 gets the deleted state information through the processing section 21 and gives notice to the different gateway.

As described above, when the master gateway processes a packet and changes the state information, the state information change is synchronized between the gateway 1 and the different gateway, so that if it becomes impossible for the master gateway to continue processing due to a fault, etc., it is made possible to continue the communications conducted through the master gateway still after the master gateway is switched to the different gateway. Since synchronization is conducted if change occurs in the state information, only the difference is transmitted, thereby eliminating the need for conducting unnecessary communications. Further, the server and the client PC can conduct communications without being conscious of switching between the gateways.

In the description of the embodiment, the number of the gateways is two, but is not limited to two and may be more than two. If a plurality of slave gateways exist, when one of the slave gateways is switched to the master gateway, it shares the state information with other slave gateways in synchronization with each other, whereby the gateways can be furthermore made redundant and highly available.

### Second Embodiment

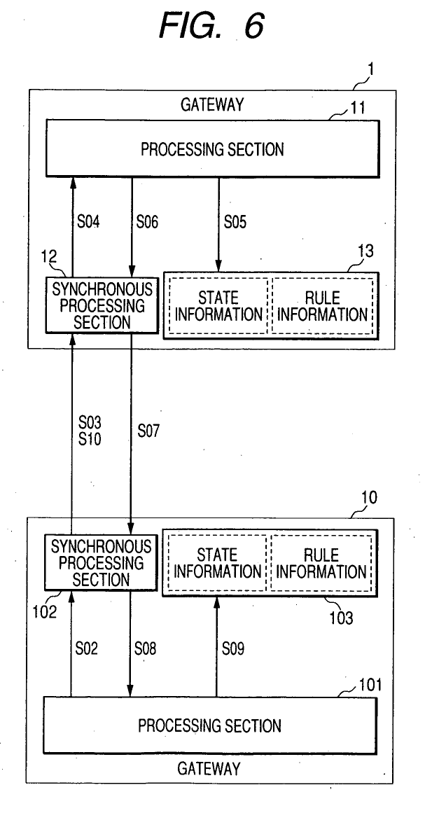

FIG. 6 is a block diagram to show a second embodiment according to the invention.

In the second embodiment, a gateway is added. The configuration of each gateway is the same as that described above and therefore will not be discussed again. In FIG. 6, a gateway 2 is not shown for convenience.

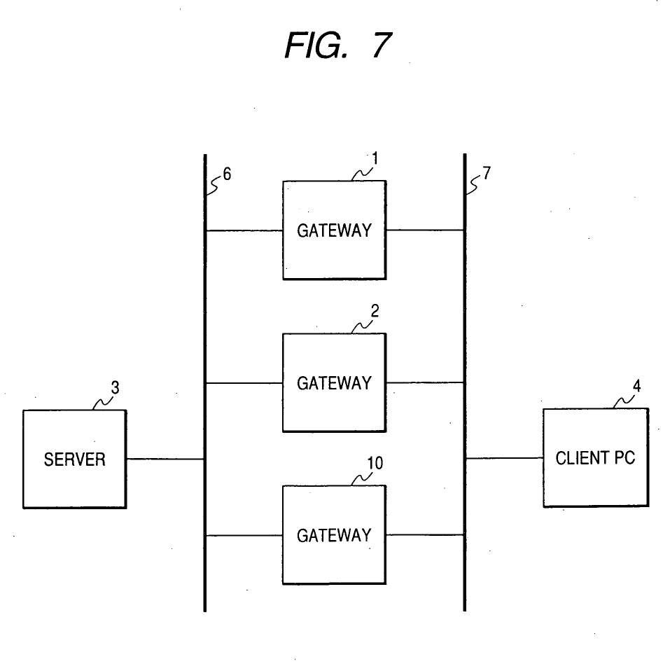

FIG. 7 is a diagram to describe the configuration of networks according to the invention.

In FIG. 7, a server 3 and gateways 1, 2, and 10 are connected by a network 6. A client PC 4 and the gateways 1, 2, and 10 are connected by a network 7. The gateways 1 and 2 operate as one group in communications between the server 3 and the client PC 4. At this time, the gateway 1 slave. The gateway 10 does not operate (no power is turned on, the function is not effective, etc.,).

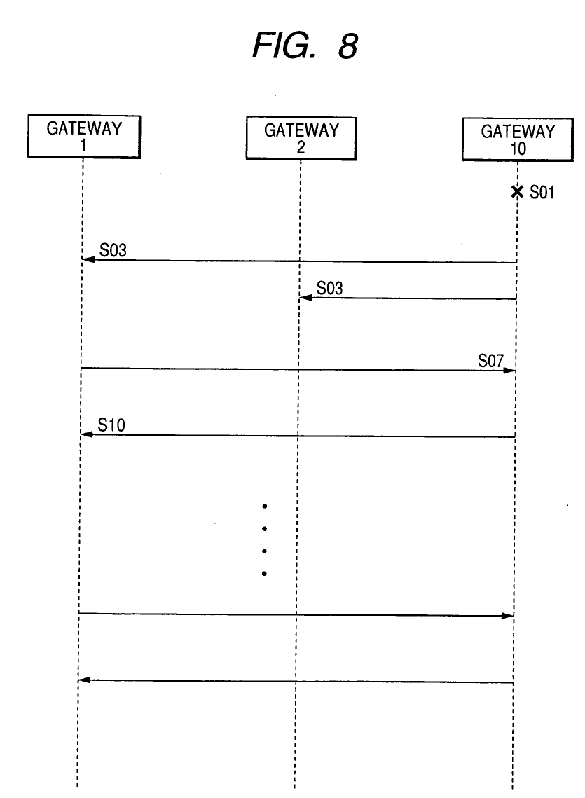

FIG. 8 is a packet flow chart in the configuration in FIG. 6. The operation of the embodiment will be discussed with FIGS. 6 and 8. The following processing steps are made to correspond to signal names in FIGS. 6 and 8.
(S01) The gateway 10 starts to operate because it is started or the function is made effective, etc.
(S02) A processing section 101 of the gateway 10 notifies a synchronous processing section 102 that the function becomes effective.
(S03) The synchronous processing section 102 of the gateway 10 transmits a request to all gateways to which of the gateway 10 belongs for synchronizing with state information of other gateways.
(S04) A synchronous processing section 12 of the gateway 1 of the master receives the request at S03 transmitted from the gateway 10. A synchronous processing section 22 of the gateway 2 of a slave discards the request at S03. The synchronous processing section 12 of the gateway 1 notifies a processing section 11 that the request is received.
(S05) The processing section 11 of the gateway 1 references the state information in a storage section 13 and collects the state information.
(S06) The processing section 11 of the gateway 1 sends the state information to the synchronous processing section 12.
(S07) The synchronous processing section 12 of the gateway 1 transmits the state information to the gateway 10.
(S08) The synchronous processing section 102 of the gateway 10 receives the state information at S07 and sends the state information to the processing section 101.
(S09) The processing section 101 of the gateway 10 updates the state information in a storage section 103 based on the received state information.
(S10) If necessary, the synchronous processing section 102 of the gateway 10 transmits a reception notification to the gateway 1.

Thus, other gateways are notified that the function of the added gateway becomes effective and a request to send state information is transmitted to the master gateway, whereby it is made possible to add a gateway as desired.

### Third Embodiment

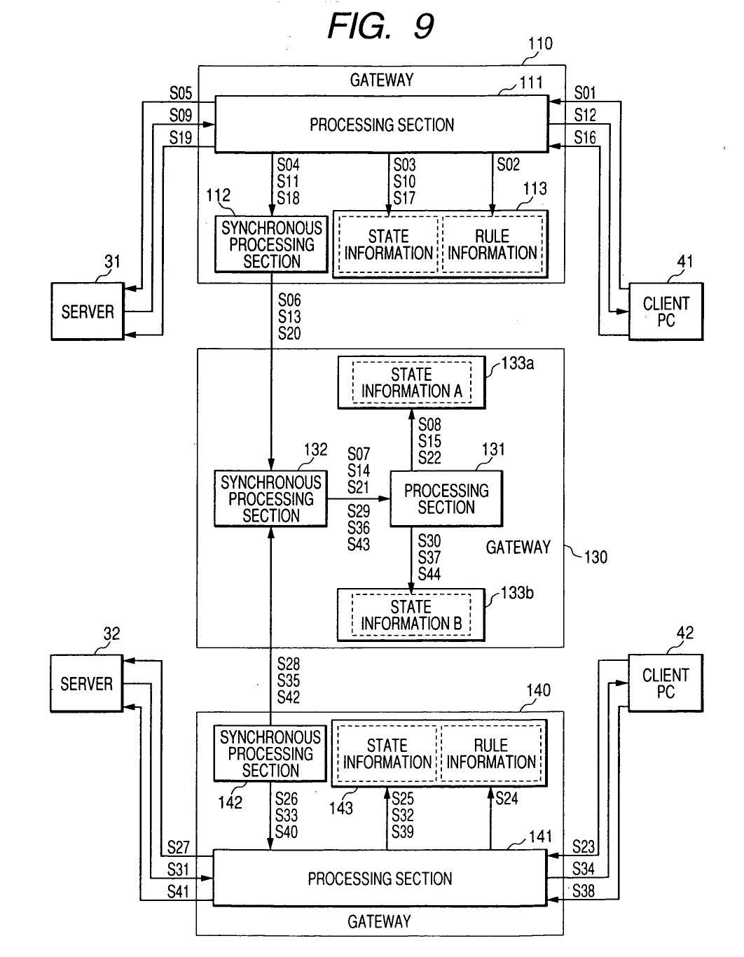

FIG. 9 is a block diagram to show a third embodiment according to the invention.

In FIG. 9, like the above-described gateway, a gateway 110, 140 is made up of a processing section 111, 141, a synchronous processing section 112, 142, and a storage section 113, 143 and therefore the configuration described later are not shown in the figure for convenience.

A gateway 130 has a processing section 131, storage sections 133a and 133b, and a synchronous processing section 132. The processing section 131 and the synchronous processing section 132 are functional blocks similar to those of any other gateway.

Rule information (not shown) and state information A are stored in the storage section 133a by the processing section 131, and state information B is stored in the storage section 133b by the processing section 131. The state information A is state information of a first group described later and the state information B is state information of a second group.

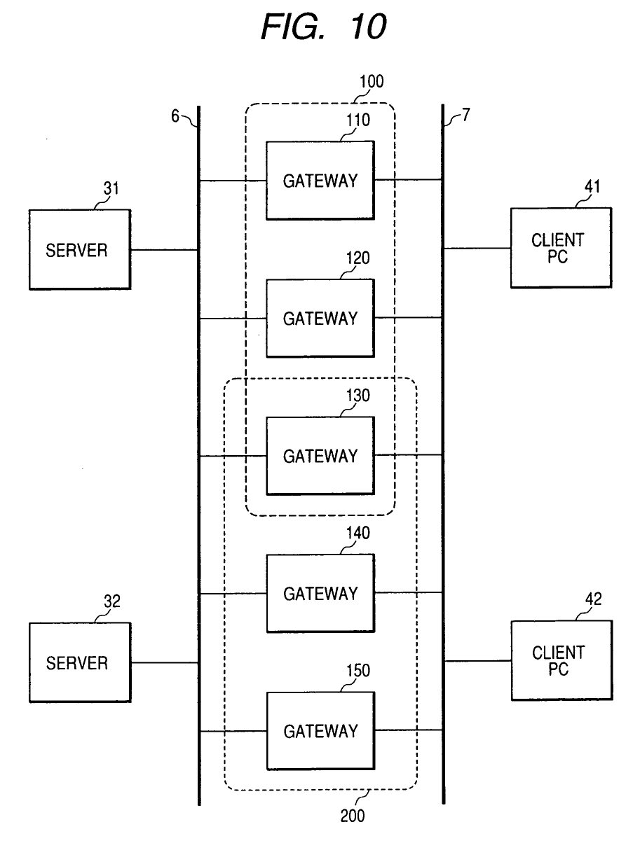

FIG. 10 is a diagram to describe the configuration of networks according to the invention.

In FIG. 10, the gateways 110, 120, 130, 140, and 150 and the servers 31 and 32 are connected by a network 6, and the gateways 110, 120, 130, 140, and 150 and the client PCs 41 and 42 are connected by a network 7.

The gateways 110, 120, and 130 belong to a first group 100 of a gateway group and operate like a virtual gateway. The gateways 130, 140, and 150 belong to a second group 200 of a gateway group and operate like a virtual gateway.

At this time, in the first group 100, the gateway 110 operates as the master and the gateways 120 and 130 operate as slaves. In the second group 200, the gateway 140 operates as the master and the gateways 150 and 130 operate as slaves.

The server 31 and the client PC 41 are set so as to use the first group 100 of the gateway group. The server 32 and the client PC 42 are set so as to use the second group 200 of the gateway group.

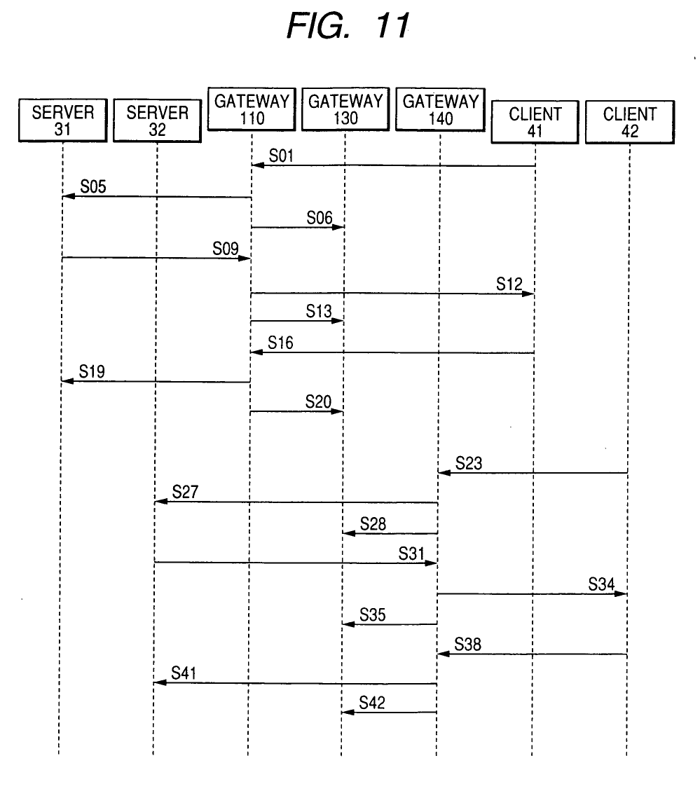

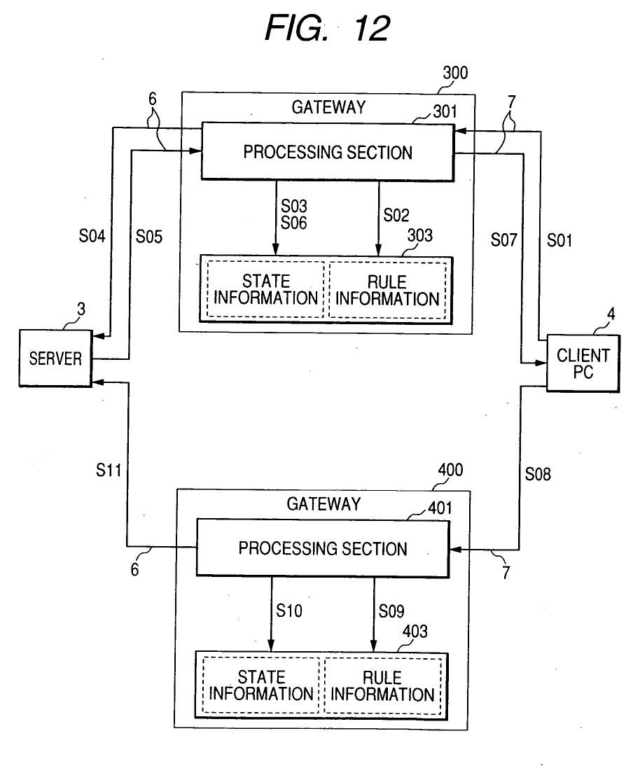

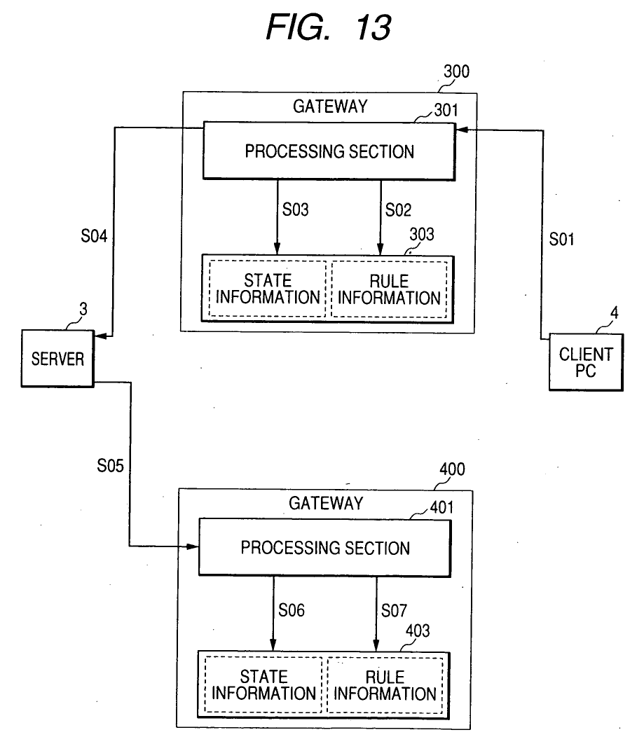

FIG. 11 is a packet flow chart in the configuration in FIG. 9. The operation will be discussed with FIGS. 9 and 11. The following processing steps are made to correspond to signal names in FIGS. 9 and 11.
(S01) The client PC 41 starts communications with the server 31.
(S02) The processing section 111 of the gateway 110 receives the packet transmitted from the client PC 41 at S01. The processing section 111 references the state information and the rule information in the storage section 113 in order for determining whether or not the packet is to be processed. Since the packet at S01 is the first processed packet in the processing section 111 of the gateway 110, no corresponding entry exists in the state information in the storage section 113. The processing section 111 references the rule information for determining whether or not the packet is to be processed.
(S03) If the packet is to be processed, the processing section 111 processes the packet received at S01 and adds a new entry to the state information in the storage section 113 based on the rule information.
(S04) The processing section 111 of the gateway 110 updates the state information and thus sends a notification to the synchronous processing section 112 in the gateway 110.
(S05) The processing section 111 of the gateway 110 transmits the processed packet to the server 31.
(S06) The gateway 110 gives notice of the updated state information to a different gateway belonging to the first group almost at the same time as or before or after the packet at S05.
(S07) The synchronous processing section 132 of the gateway 130 receives S06 of the notice packet of the state information and passes the information to the processing section 131.
(S08) The processing section 131 of the gateway 130 updates the state information A for the first group in the storage section 133a based on the received information. Here, the state information is retained for each group for convenience, but need not necessarily be retained separately.
(S09) The server 31 receives the packet transmitted at S05 and makes a response.
(S10) The processing section 111 of the gateway 110 receives the packet transmitted from the server 31 at S09. The processing section 111 references the state information and the rule information in order for determining whether or not the packet is to be processed. Since the packet at S09 is the packet concerning communications, already processed by the gateway 110, the corresponding state information is stored in the storage section 113 and therefore the packet is determined to be processed. Because of performing packet processing, the processing section 111 updates the state information.
(S11) If the state information is updated, the processing section 111 of the gateway 110 sends a notification to the synchronous processing section 112 in the gateway 110 to give notice of the updated state information to the different gateway.
(S12) The processing section 111 of the gateway 110 transmits the processed packet to the client PC 41.
(S13) If the state information is updated, the synchronous processing section 112 of the gateway 110 gets the updated state information through the processing section 111 almost at the same time as or before or after the packet at S12 and gives a notice to the different gateway belonging to
(S14) The synchronous processing section 132 of the gateway 130 receives S13 of the notice packet of the state information and passes the information to the processing section 131.
(S15) The processing section 131 of the gateway 130 updates the state information A for the first group in the storage section 133a based on the received information.
(S16) The client PC 41 transmits a packet to the server 31.
(S17) The processing section 111 of the gateway 110 receives the packet transmitted from the client PC 41 at S16. The processing section 111 references the state information and the rule information in the storage section 113 in order for determining whether or not the packet is to be processed. Since the packet at S16 is the packet concerning communications, already processed by the processing section 111 of the gateway 110, the corresponding state information is stored in the storage section 113 and therefore the packet is determined to be processed. Because of performing packet processing, the processing section 111 updates the state information.
(S18) If the state information is updated, the processing section 111 of the gateway 110 sends a notification to the synchronous processing section 112 in the gateway 110 to give notice of the updated state information to the different gateway.
(S19) The processing section 111 of the gateway 110 transmits the processed packet to the server 31.
(S20) If the state information is updated, the synchronous processing section 112 of the gateway 110 acquires the updated state information through the processing section 111 almost at the same time as or before or after the packet at S19 and gives a notice to the different gateway belonging to the first group 100.
(S21) The synchronous processing section 132 of the gateway 130 receives S20 of the notice packet of the state information and passes the information to the processing section 131.
(S22) The processing section 131 of the gateway 130 updates the state information A for the first group in the storage section 133a based on the received information.
(S23) The client PC 42 starts communications with the server 32.
(S24) The processing section 141 of the gateway 140 receives the packet transmitted from the client PC 42 at S23. The processing section 141 references the state information and the rule information in the storage section 143 in order for determining whether or not the packet is to be processed. Since the packet at 523 is the first processed packet in the processing section 141 of the gateway 140, no corresponding entry exists in the state information in the storage section 143. The processing section 141 references the rule information in the storage section 143 for determining whether or not the packet is to be processed.
(S25) If the packet is to be processed, the processing section 141 processes the packet received at S23 and adds a new entry to the state information in the storage section 143 based on the rule information.
(S26) The processing section 141 of the gateway 140 updates the state information and thus sends a notification to the synchronous processing section 142 in the gateway 140.
(S27) The processing section 141 of the gateway 140 transmits the processed packet to the server 32.
(S28) The synchronous processing section 142 of the gateway 140 gets the updated state information through the processing section 141 almost at the same time as or before or after the packet at S27 and gives a notice to a different gateway belonging to the second group 200.
(S29) The synchronous processing section 132 of the gateway 130 receives S28 of the notice packet of the state information and passes the information to the processing section 131.
(S30) The processing section 131 of the gateway 130 updates the state information B for the second group in the storage section 133b based on the received information.
(S31) The server 32 receives the packet transmitted at S27 and makes a response.
(S32) The processing section 141 of the gateway 140 receives the packet transmitted from the server 32 at S31. The processing section 141 references the state information and the rule information in the storage section 143 in order for determining whether or not the packet is to be processed. Since the packet at S32 is the packet concerning communications, already processed by the processing section 141 of the gateway 140, the corresponding state information is stored in the storage section 143 and therefore the packet is determined to be processed. Because of performing packet processing, the processing section 141 updates the state information.
(S33) If the state information is updated, the processing section 141 of the gateway 140 sends a notification to the synchronous processing section 142 in the gateway 140 to give notice of the updated state information to the different gateway.
(S34) The processing section 141 of the gateway 140 transmits the processed packet to the client PC 42.
(S35) If the state information is updated, the synchronous processing section 142 of the gateway 140 gets the updated state information through the processing section 141 almost at the same time as or before or after the packet at S34 and gives a notice to the different gateway belonging to the second group.
(S36) The synchronous processing section 132 of the gateway 130 receives S35 of the notice packet of the state information and passes the information to the processing section 131.
(S37) The processing section 131 of the gateway 130 updates the state information B for the second group in the storage section 133b based on the received information.
(S38) The client PC 42 transmits a packet to the server 32.
(S39) The processing section 141 of the gateway 140 receives the packet transmitted from the client PC 42 at S38. The processing section 141 references the state information and the rule information in the storage section 143 in order for determining whether or not the packet is to be processed. Since the packet at S38 is the packet concerning communications, already processed by the processing section 141 of the gateway 140, the corresponding state information is stored in the storage section 143 and therefore the packet is determined to be processed. Because of performing packet processing, the processing section 141 updates the state information.
(S40) If the state information is updated, the processing section 141 of the gateway 140 sends a notification to the synchronous processing section 142 in the gateway 140 to give notice of the updated state information to the different gateway.
(S41) The processing section 141 of the gateway 140 transmits the processed packet to the server 32.
(S42) If the state information is updated, the synchronous processing section 142 of the gateway 140 gets the updated state information through the processing section 141 almost at the same time as or before or after the packet at S41 and gives a notice to the different gateway belonging to the second group 200.
(S43) The synchronous processing section 132 of the gateway 130 receives S43 of the notice packet of the state information and passes the information to the processing section 131.
(S44) The processing section 131 of the gateway 130 updates the state information B for the second group in the storage section 133b based on the received information.

Thus, when a plurality of gateway groups exist and a slave gateway belonging to every group exists, the state information of the master gateway in each group is shared with the slave gateway belonging to every group in synchronization. The slave gateway is thus installed so as to belong to a plurality of groups, whereby the system can be designed flexibly.

In the embodiments described above, the processing section and the synchronous processing section are implemented as an arithmetic-logic unit and software. Therefore, the processing section and the synchronous processing section may be provided separately as in the embodiments as functional blocks or one processing section into which the functions are integrated may be provided. The processing section can also bear some or all of the functions of the synchronous processing section or the synchronous processing section can also bear some or all of the functions of the processing section.

It is to be understood that the invention is not limited to the specific embodiments described above and that the invention contains various changes and modifications without departing from the spirit and the scope of the invention.

What is claimed is:

1. A gateway system for transiting communications at the boundary between networks, comprising:
a master gateway which processes a communication packet, updates state information based on the processing of the communication packet, and transmits the updated state information; and
at least one slave gateway which receives state information transmitted from the master gateway, and stores the received state information as state information of the slave gateway,
wherein the slave gateway operates instead of the master gateway based on the stored state information.

2. The gateway system according to claim 1, further comprising:
a plurality of the master gateways,
wherein the slave gateway stores state information transmitted from each of the plurality of the master gateways.

3. The gateway system according to claim 1,
wherein the master gateway comprises:
a processing section which processes a communication packet, and updates state information based on the processing of the communication packet;
a storage section which stores state information; and
a synchronous processing section which transmits state information.

4. The gateway system according to claim 1,
wherein the slave gateway comprises:
a synchronous processing section which receives state information transmitted from the master gateway;
a processing section which processes communication packet, and updates the currently stored state information to the received state information; and
a storage section which stores state information.

5. The gateway system according to claim 4,
wherein the processing section of the salve gateway updates state information when the processing section processes a communication packet, and the synchronous processing section transmits the updated state information to another slave gateway.

6. The gateway system according to claim 3,
wherein the synchronous processing section of the salve gateway notifies another gateway that a function becomes effective at an operation start time, and transmits request signal of state information to the master gateway.
